(19) United States
(12) Patent Application Publication
(10) Pub. No.: US 2017/0182596 A1
(43) Pub. Date: Jun. 29, 2017

(54) APPARATUS FOR MANUFACTURING THREE-DIMENSIONAL OBJECT

(71) Applicant: SENTROL Co., Ltd., Seoul (KR)

(72) Inventor: Takada Toru, Seoul (KR)

(21) Appl. No.: 15/182,904

(22) Filed: Jun. 15, 2016

(30) Foreign Application Priority Data
Dec. 29, 2015 (KR) 10-2015-0188160

(51) Int. Cl. B23K 26/342; B23K 26/60; B33Y 50/02; B29C 67/00; B33Y 30/00

(52) U.S. Cl. CPC B23K 26/342; B29C 67/0077; B29C 67/0088; B33Y 30/00; B33Y 50/02; B29C 67/0085; B23K 26/60

(57) ABSTRACT

An apparatus for manufacturing a three-dimensional object, and more particularly, to an apparatus for manufacturing a three-dimensional object that can reduce an entire equipment size by enabling powder to be supplied from an upper portion of a worktable and that can improve work efficiency by enabling powder to be automatically supplied is provided. The apparatus for manufacturing a three-dimensional object includes: a first guide beam installed at an upper portion of a worktable; a dispenser installed to sliding move in a horizontal direction at the first guide beam and having a nozzle portion that discharges powder to the worktable at a lower end portion; first and second supports installed at a lower portion of both end portions, respectively of the first guide beam to block and close an inlet of a nozzle portion of the dispenser approaching by sliding moving to both end portions of the first guide beam; and a blade installed to move in a horizontal direction between the worktable and the dispenser to push and flatten powder supplied to the worktable.

### BACKGROUND OF THE INVENTION

### Field of the Invention

The present invention relates to an apparatus for manufacturing three-dimensional object, and more particularly, to an apparatus for manufacturing a three-dimensional object that can reduce an entire equipment size by enabling powder to be supplied from an upper portion of a worktable and that can improve work efficiency by enabling powder to be automatically supplied.

### Description of the Related Art

Nowadays, a research on a three-dimensional printer that can shape a target object using three-dimensional (3D) data has been actively performed. Because a complex structure of product can be easily shaped and produced with a planned design, it is expected that a 3D printer market will largely increase in the future.

A stacked type 3D printer using powder repeats a work that spreads powder in a small thickness of about 30-150 um and that bonds the powder with a bonding resin or that sinters or melts the powder using laser to combine the powder and that spreads again the powder in a small thickness of about 30-150 um.

In such a conventional stacked type 3D printer, a powder stage filled with powder is separately installed at one side of a worktable and a work is performed and thus the conventional stacked type 3D printer has a structure that enables powder to be continuously supplied to the worktable while the powder stage moves upward.

Therefore, in the conventional stacked type 3D printer, as a size of a 3D product to produce increases, a size of a powder stage should also increase and thus there is a problem that an entire apparatus size cannot be reduced to a predetermined size or less.

Further, in order to fill powder into a powder stage, a work that periodically stops an equipment and that resupplies powder should be performed and thus there is a problem that work efficiency is deteriorated.

### SUMMARY OF THE INVENTION

The present invention has been made in view of the above problems and provides an apparatus for manufacturing a 3D object that can reduce an entire equipment size by enabling powder to be supplied from an upper portion of a worktable and that can improve work efficiency by enabling powder to be automatically supplied.

In accordance with an aspect of the present invention, an apparatus for manufacturing a 3D object includes: a first guide beam installed at an upper portion of a worktable; a, dispenser installed to sliding move in a horizontal direction at the first guide beam and having a nozzle portion that discharges powder to the worktable at a lower end portion; first and second supports installed at a lower portion of both end portions, respectively of the first guide beam to block and close an inlet of the nozzle portion of the dispenser approaching by sliding moving to both end portions of the first guide beam; and a blade installed to move in a horizontal direction between the worktable and the dispenser to push and flatten powder supplied to the worktable.

At one side of the first guide beam, a first guide rail may be installed in a lengthwise direction, and at one side of the dispenser, a first guide block coupled to sliding move to the first guide rail may be installed.

At one end of the first and second supports, first and second supporting plates extended in a vertical direction to support one side surface of the dispenser may be formed.

At the first and second supporting plates, through-holes for discharging powder stacked at the first and second supports to the outside may be each formed, and at a lower portion of the first and second supports, first and second powder induction plates downwardly inclined toward a central portion of the worktable to receive powder discharged through the through-hole and to resupply the powder to the worktable may be installed.

At the inside of the dispenser, a first sensor that measures a remaining powder amount to transmit the remaining powder amount to a controller may be installed, at a powder supply tube, a second sensor that measures a present location of the dispenser to transmit the present location to the controller may be installed, and at an upper portion of one end portion of the first guide beam, a powder supply tube opened by the controller to supply powder into the dispenser may be installed.

### Advantages

in an apparatus for manufacturing a 3D object according to the present invention, because powder is supplied from an upper portion of a worktable, a powder stage is not required, unlike a conventional case. Therefore, an entire equipment size can be reduced.

An apparatus for manufacturing a 3D object according to the present invention enables powder to be automatically supplied to a dispenser that discharges powder while a work is performed. Therefore, unlike a conventional case, it is unnecessary to stop a work for supplying powder and work efficiency can be thus improved.

### BRIEF DESCRIPTION OF THE DRAWINGS

The objects, features and advantages of the present invention will be more apparent from the following detailed description in conjunction with the accompanying drawings, in which:

FIGS. 1 and 2 are diagrams illustrating art entire structure of an apparatus for manufacturing a 3D object according to an exemplary embodiment of the present invention; and

FIG. 3 is a diagram illustrating an operation state of an apparatus for manufacturing a 3D object according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. Like reference numerals designate like elements throughout the specification. Detailed descriptions of well-known functions and structures incorporated herein may be omitted to avoid obscuring the subject matter of the present invention.

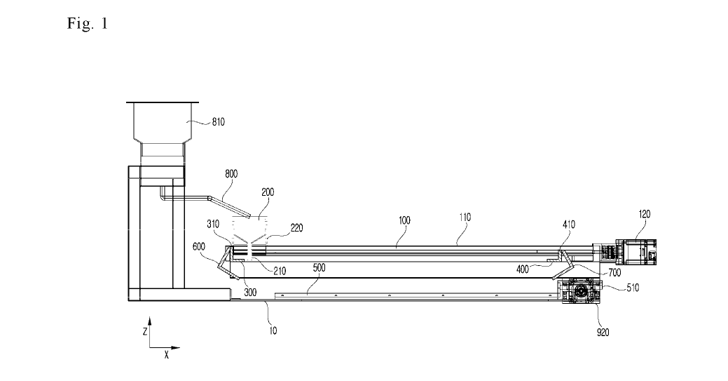

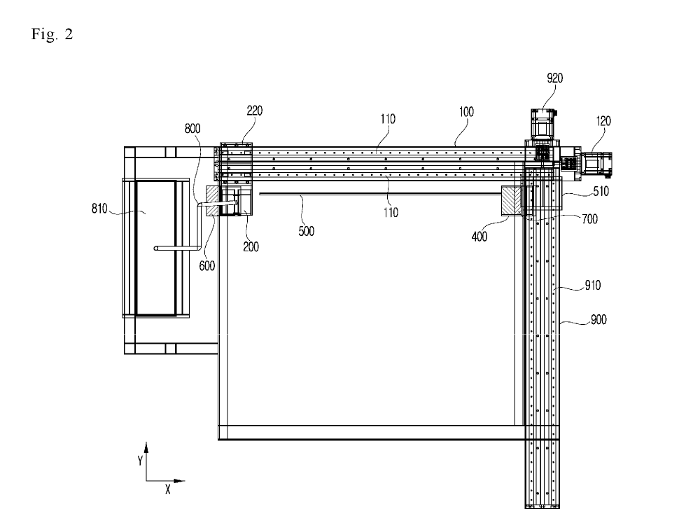

FIGS. 1 and 2 are diagrams illustrating an entire structure of an apparatus for manufacturing a 3D object according to an exemplary embodiment of the present invention.

As shown in FIGS. 1 and 2, an apparatus for manufacturing a 3D object according to an exemplary embodiment of the present invention includes a first guide beam 100, a dispenser 200, first and second supports 300 and 400, and a blade 500.

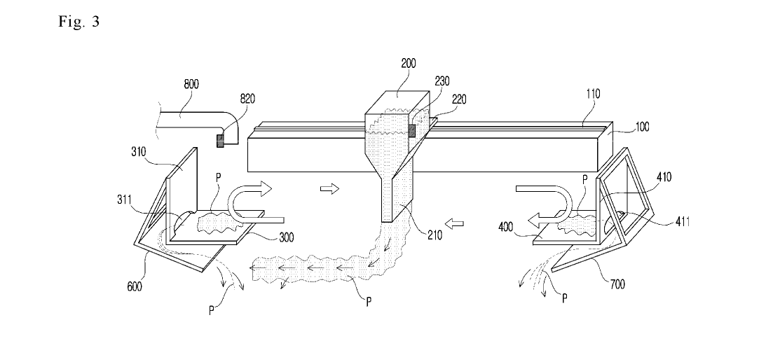

The first guide beam 100 is installed in a lengthwise direction at an upper portion of a worktable 10 in which a 3D object is produced. When a production process is performed, in order to always stack powder P (see FIG. 3) such as metal, synthetic resin, and sand at the same height at an upper surface of the worktable 10, the worktable 10 has a structure that lifts in an up and down direction (Z-axis direction). For this reason, at a lower portion of the worktable 10, a driving device (not shown) such as a stepping motor is installed.

The dispenser 200 is installed to sliding move in a horizontal direction in the first guide beam 100, and at a lower end portion thereof, a nozzle portion 210 that discharges powder P to the worktable 10 is formed.

While a 3D object production process is performed, the dispenser 200 reciprocates in a horizontal direction (X-axis direction) along the first guide beam 100 and discharges powder P filled therein to the worktable 10 through the nozzle portion 210, thereby enabling the powder P to be continuously stacked at the worktable 10.

For a horizontal movement of such a dispenser 200, at one side of the first guide beam 100, a first guide rail 110 is installed in a lengthwise direction, and at one side of the dispenser 200, a first guide block 220 coupled to sliding move to the first guide rail 110 is installed.

Further, at one end of the first guide beam 100, a first driving motor 120 for moving the first guide block 220 is installed. Therefore, when the first guide block 220 starts to move along the first guide rail 110 by the first driving motor 120, a sliding movement of the dispenser 200 is naturally performed. A horizontal movement structure of the dispenser 200 is not limited thereto and may be changed to various forms such as a lead screw form.

The first and second supports 300 and 400 are each installed at a lower portion of both end portions of the first guide beam 100 to block and close an inlet of the nozzle portion 210 of the dispenser 200 approaching by sliding moving to both end portions of the firs: guide beam 100.

As described above, when powder P is stacked at an upper surface of the worktable 10 by the dispenser 200, a work that pushes and flattens the powder P using the blade 500 to be described hereinafter and that melts and combines the powder P using laser is performed. While such a work is performed, the dispenser 200 stops at one end of the first guide beam 100, and in this case, when the powder P is discharged to the worktable 10 through the nozzle portion 210, a material may he wasted and a product failure may occur and thus by installing the first support 300 and the second support 400 at both end portions, respectively, of the first guide beam 100, at both end portions of the first guide beam 100, the nozzle portion 210 of the dispenser 200 is closed.

At one end of such first and second supports 300 and 400, first and second supporting plates 310 and 410 extended in a vertical direction are formed. As described above, when the dispenser 200 stops at one end of the first guide beam 100, the first and second supporting plates 310 and 410 support one side surface of the dispenser 200 to enable the dispenser 200 to stably maintain a stop state at a corresponding location.

FIG. 3 is a diagram illustrating an operation state of an apparatus for manufacturing a 3D object according to an exemplary embodiment of the present invention.

Further, as shown in FIG. 3, in the first and second supporting plates 310 and 410, through-holes 311 and 411 for discharging powder P stacked at the first and second supports 300 and 400, respectively, to the outside are formed, and at a lower portion of the first and second supports 300 and 400, first and second powder induction plates 600 and 700 that receive powder P discharged through the through-holes 311 and 411, respectively, to resupply the powder P to the worktable 10 are installed.

As described above, in a state in which the dispenser 200 is stopped, the nozzle portion 210 is closed by the first and second supports 300 and 400, but m a state which a small gap exists between the first and second supports 300 and 400 and the nozzle portion 210, when a work is performed, a small amount of powder P is stacked at an upper surface of the first and second supports 300 and 400.

Therefore, when the dispenser 200 moves to the first and second supports 300 and 400, powder P stacked at the first and second supports 300 and 400 is pushed by the dispenser 200 to move toward first and second supporting plates 310 and 410 and thus through-holes 311 and 411 are formed at the first and second supporting plates 310 and 410, respectively, and at a lower portion of the first and second supports 300 and 400, when the first and second powder induction plates 600 and 700 are installed, powder P discharged to the outside through the through-holes 311 and 411 is dropped to the first and second powder induction plates 600 and 700 and is resupplied to the worktable 10, thereby minimizing powder waste.

Here, the first and second powder induction plates 600 and 700 are formed to be downwardly inclined toward a central portion of the worktable 10 to be naturally resupplied powder P dropping to an upper surface to the worktable 10.

At an upper portion of one end portion of the first guide beam 100, a powder supply tube 800 is installed. The powder supply tube 800 is connected to a powder storage container 810 to supply powder P into the dispenser 200, when the dispenser 200 stops at one end of the first guide beam 100. Therefore, while a work is performed, because powder is continuously supplied into the dispenser 200 through the powder supply tube 800, it is unnecessary to stop a work for supplying powder, unlike a conventional case.

Here, it is preferable that a first sensor 230 that measures a remaining powder amount to transmit the remaining powder amount to a controller (not shown) is installed within the dispenser 200 and that a second sensor 820 that measures a present location of the dispenser 200 to transmit the present location to the controller is installed in the powder supply tube 800,

The controller receives a signal of the first and second sensors 230 and 820, and the dispenser 200 locates at a lower portion of the powder supply tube 800, and when a remaining powder amount within the dispenser 200 is a predetermined amount or less, the controller controls powder P stored at the powder storage container 810 to be filled into the dispenser 200 through the powder supply tube 800 by operating a vacuum pump while opening the powder supply tube 800. Such a process is repeatedly performed while a 3D object production process is performed.

The blade 500 is installed to move in a horizontal direction between the worktable 10 and the dispenser 200 to push and flatten powder P supplied to the worktable 10 by the dispenser 200, as described above.

Specifically, when powder P is stacked at the worktable 10, the blade 500 sliding moves in a horizontal direction along a second guide beam 900 installed in a vertical direction (Y-axis direction) to the first guide beam 100 to push and flatten the powder P stacked at the worktable 10. For this reason, at the second guide beam 900, a second guide rail 910 is installed, and at one end of the blade 500, a second guide block 510 that sliding moves along the second guide rail 910 is installed.

Further, at one end of the second guide beam 900, a second driving motor 920 for moving the second guide block 510 is installed. Therefore, when the second guide block 510 starts to move along the second guide rail 910 by the second driving motor 920, a sliding movement is naturally performed in a horizontal direction (Y-axis direction) of the blade 500. A horizontal movement structure of such a blade 500 is not limited thereto and may be changed in various forms such as a lead screw form.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

[Description of symbols]

| | |
|---|---|
| 10: worktable | 100: first guide beam |
| 110: first guide rail | 120: first driving motor |
| 200: dispenser | 210: nozzle portion |
| 220: first guide block | 300, 400: first and second supports |
| 310, 410: first and second supporting | 311, 411: through-hole |
| plates | |
| 500: blade | 510: second guide block |

600, 700: first and second powder induction plates

| | |
|---|---|
| 800: powder supply tube | 810: powder storage container |
| 230, 820: first and second sensors | 900: second guide beam |
| 910: second guide rail | 920: second driving motor |
| P: powder | |

What is claimed is:

1. An apparatus for manufacturing a three-dimensional object, comprising:
a first guide beam installed at an upper portion of a worktable;
a dispenser installed to sliding move in a horizontal direction at the first guide beam and having a nozzle portion that discharges powder to the worktable at a lower end portion;
first and second supports installed at a lower portion of both end portions, respectively of the first guide beam to block and close an inlet of the nozzle portion of the dispenser approaching by sliding moving to both end portions of the first guide beam; and
a blade installed to move in a horizontal direction between the worktable and the dispenser to push and flatten powder supplied to the worktable.

2. The apparatus of claim 1, wherein at one side of the first guide beam, a first guide rail is installed in a lengthwise direction, and
at one side of the dispenser, a first guide block coupled to sliding move to the first guide rail is installed.

3. The apparatus of claim 1, wherein at one end of the first and second supports, first and second supporting plates extended in a vertical direction to support one side surface of the dispenser are formed.

4. The apparatus of claim 3, wherein at the first and second supporting plates, through-holes for discharging powder stacked at the first and second supports to the outside are each formed, and
at a lower portion of the first and second supports, first and second powder induction plates downwardly inclined toward a central portion of the worktable to receive powder discharged through the through-hole and to resupply the powder to the worktable are installed.

5. The apparatus of claim 1, wherein at the inside of the dispenser, a first sensor that measures a remaining powder amount to transmit the remaining powder amount to a controller is installed,
at a powder supply tube, a second sensor that measures a present location of the dispenser to transmit the present location to the controller is installed, and
at an upper portion of one end portion of the first guide beam, a powder supply tube opened by the controller to supply powder into the dispenser is installed.
